(19) United States
(12) Patent Application Publication
(10) Pub. No.: US 2021/0369035 A1
(43) Pub. Date: Dec. 2, 2021

(54) Juicer

(71) Applicant: Donna Lynn Harman, Ocean City, MD (US)

(72) Inventor: Donna Lynn Harman, Ocean City, MD (US)

(21) Appl. No.: 17/335,754

(22) Filed: Jun. 1, 2021

Related U.S. Application Data
(60) Provisional application No. 63/033,113, filed on Jun. 1, 2020.

(51) Int. Cl. A47J 19/02; B30B 9/06

(52) U.S. Cl. CPC A47J 19/023; F16H 19/04; B30B 9/06

(57) ABSTRACT

A juicer includes a frame having a base; a first drip cup mounted on the frame and having a first outlet; a second drip cup mounted on the frame and having a second outlet; a first strainer configured to have fruit to be juiced placed thereon and arranged in the first drip cup; a second strainer configured to have fruit to be juiced placed thereon and arranged in the second drip cup; a first pressure element operatively connected to the actuator and being configured to press fruit deposited on the first strainer; a second pressure element operatively connected to the actuator and being configured to press fruit deposited on the second strainer; and, the first and second outlet being configured to guide juice from corresponding ones of the first drip cup and the second drip cup to at least one vessel filling area below the first and second drip cup.

### CROSS REFERENCE TO RELATED APPLICATION

This application claims priority of U.S. provisional application No. 63/033,113, filed Jun. 1, 2020, the entire content of which is incorporated herein by reference.

### FIELD OF THE DISCLOSURE

The disclosure relates to an apparatus for extracting juice from fruit or the like.

### TECHNICAL BACKGROUND

Juicers are used to extract juice from fruit, for example, citrus fruit such as lemons, oranges, grapefruits and the like. In the service industry, such as in a bar, manual press juicers are often used for the preparation of fresh juice. Commercially available manual juicers are limited to pressing one piece of fruit at a time. Further, commercially available juicers are configured to discharge the extracted juice into a single vessel and are prone to slide and/or move on the surface on which the juicer is placed.

### SUMMARY

It is an object of the invention to provide a juicer of improved efficiency wherein more than one piece of fruit can be pressed at a time. Further, it is an object to provide a juicer with improved stability.

The object can, for example, be achieved via a juicing device having a frame having a base, a first drip cup mounted on the frame and having a first outlet, a second drip cup mounted on the frame and having a second outlet, a first strainer configured to have fruit to be juiced placed thereon, a second strainer configured to have fruit to be juiced placed thereon, the first drip cup being configured to accommodate the first strainer, the second drip cup being configured to accommodate the second strainer, an actuator configured to be actuated by a user, a first pressure element operatively connected to the actuator and being configured, when the actuator is actuated, to press fruit deposited on the first strainer, a second pressure element operatively connected to the actuator and being configured, when the actuator is actuated, to press fruit deposited on the second strainer; and, the first outlet and the second outlet being configured to guide juice from corresponding ones of the first drip cup and the second drip cup to at least one vessel filling area below the first drip cup and the second drip cup.

According to an embodiment, the juicing device includes a diverter configured to receive juice from at least one of the first outlet of the first drip cup and the second outlet of the second drip cup. The diverter is displaceable to a first position and a second position. Further, the diverter is configured to direct juice from the first outlet and the second outlet to a single vessel when the diverter is in the first position.

In an embodiment, when the diverter is in the second position, the outlet of the first drip cup is configured to supply juice to a first vessel and the outlet of the second drip cup is configured to supply juice to a second vessel.

In an embodiment, the juicing device has a first strainer that includes a retaining pin configured to hold fruit on the first strainer. Both the first strainer and the second strainer can have a retaining pin for retaining fruit on the strainer.

In an embodiment, the juicing device is mountable on a support surface defining an edge, and, the base includes a front end having a retaining lip configured to engage the edge of the support surface so as to prevent the juicing device from moving in a direction away from the edge of the support surface.

In an embodiment, the base of the juicer includes at least two adjustable feet.

In an embodiment, the base defines a front end and a bottom; and, the at least two adjustable feet are arranged on the bottom at the front end and are configured to tilt the frame away from the front end when the feet are extended. In a further embodiment, the at least two adjustable feet are configured to adapt to a bar having a stepped and/or slanted surface.

According to an embodiment, the actuator is a handle.

In an embodiment. the juicing device further includes a rack and pinion gear assembly. The handle is connected to the first pressure element and the second pressure element via the rack and pinion gear assembly and to move the first pressure element and the second pressure element via the rack and pinion gear assembly.

In an embodiment, the rack and pinion gear assembly includes a linear rack and a circular gear. The handle is configured to rotate the circular gear when actuated. The linear gear is configured to act on the first pressure element and the second pressure element with equal force.

In an embodiment, the juicer further includes a trough. The juicer has a front end and a back end and the frame defines a vessel deposition surface. The vessel deposition surface defines an incline from the front end of the juicer toward the back end of the juicer. The trough is removably arranged at the front end and configured to receive liquid flowing down the incline.

According to an embodiment, the frame includes two lower side walls defining the vessel deposition surface therebetween so as to define a channel leading to the trough.

According to an embodiment, the first outlet guides juice to a filling area for a first vessel and the second outlet guides juice to a filling area for a second vessel.

### BRIEF DESCRIPTION OF THE DRAWINGS

The invention will now be described with reference to the drawings wherein:

FIG. 1 shows an embodiment of the juicer according to the disclosure;

FIG. 2 shows an embodiment of the juicer with a retaining lip and adjustable feet;

FIG. 3 shows the juicer of FIG. 1 with the diverter in a second position;

FIG. 4 shows a juicer having a retaining pin on a strainer;

FIG. 5 shows a juicer with a rack and pinion gear assembly;

FIG. 6 shows a juicer from a front view with a trough attached to the front end of the frame base;

FIG. 7 shows the juicer of FIG. 6 with fruit placed on the strainers; and,

FIG. 8 shows a diverter in more detail.

### DETAILED DESCRIPTION

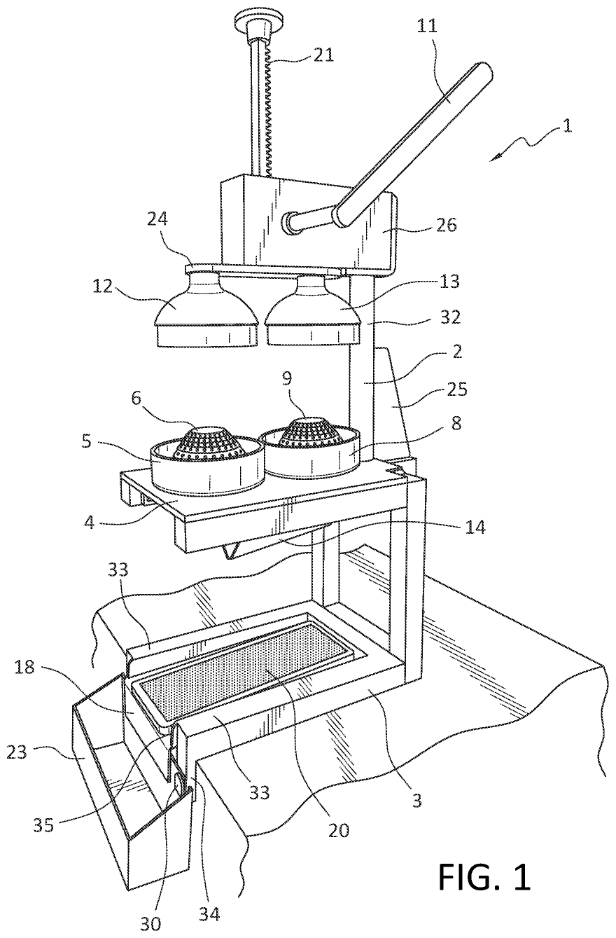

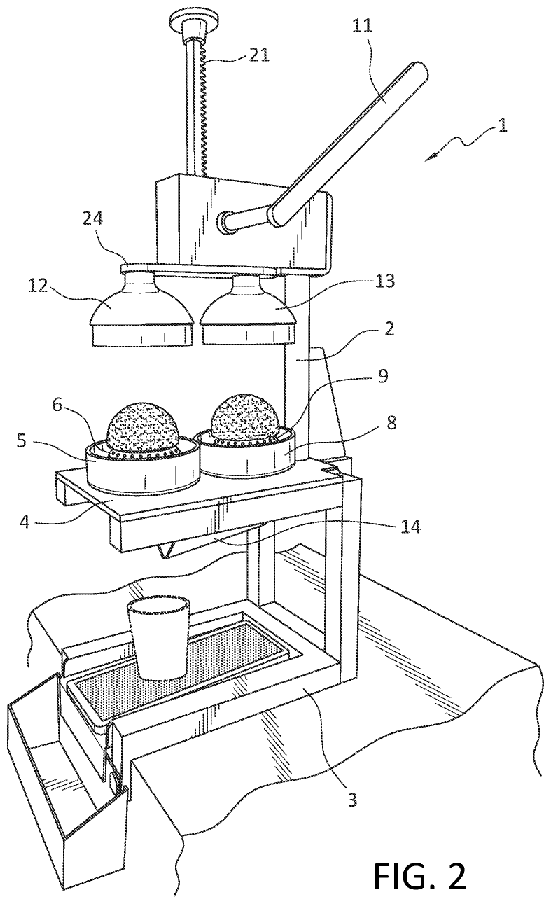

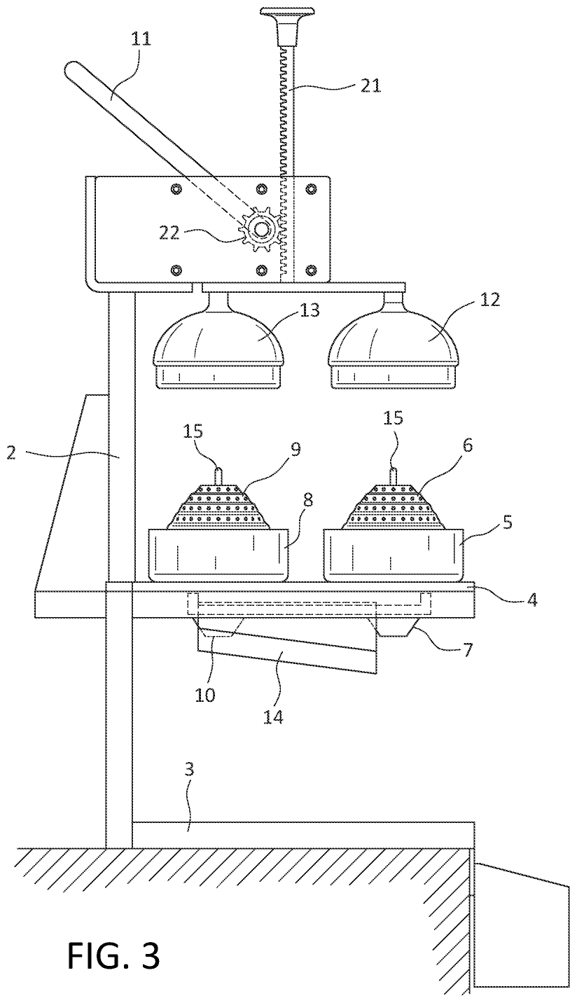

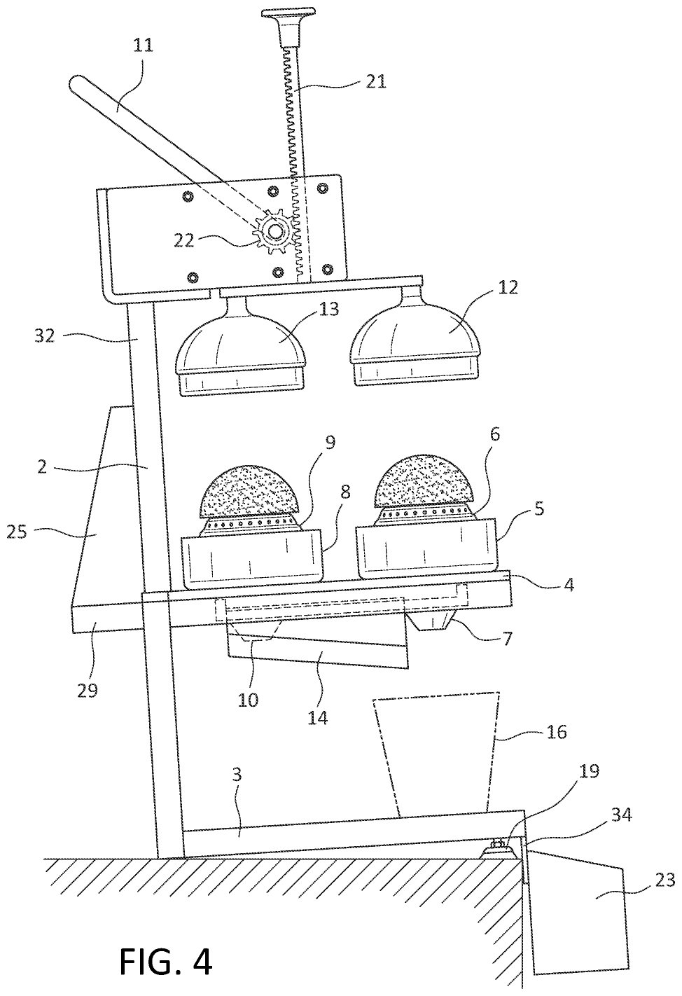

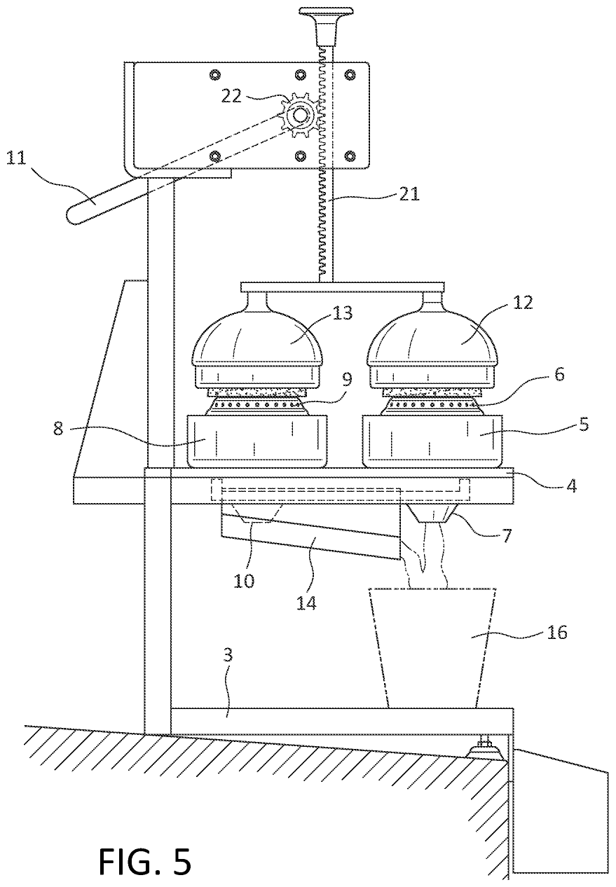

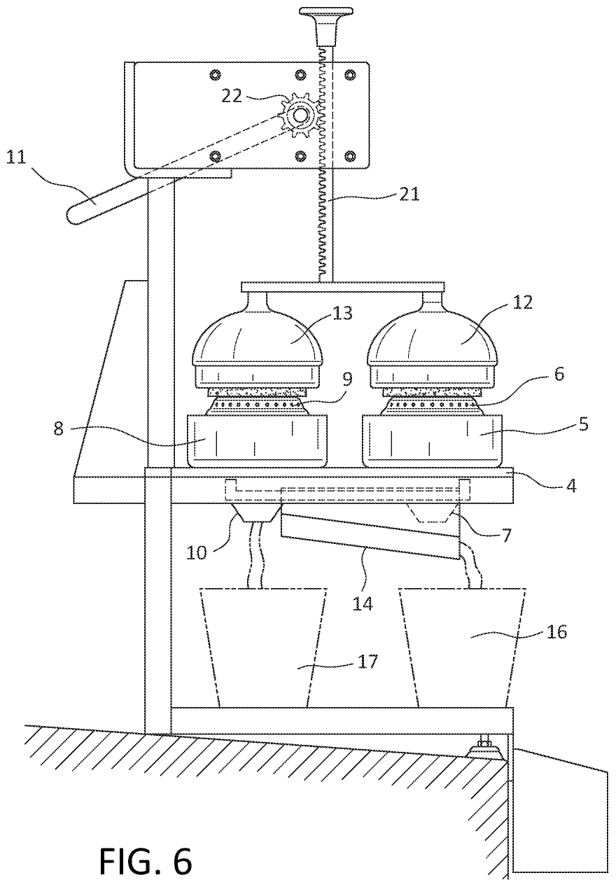

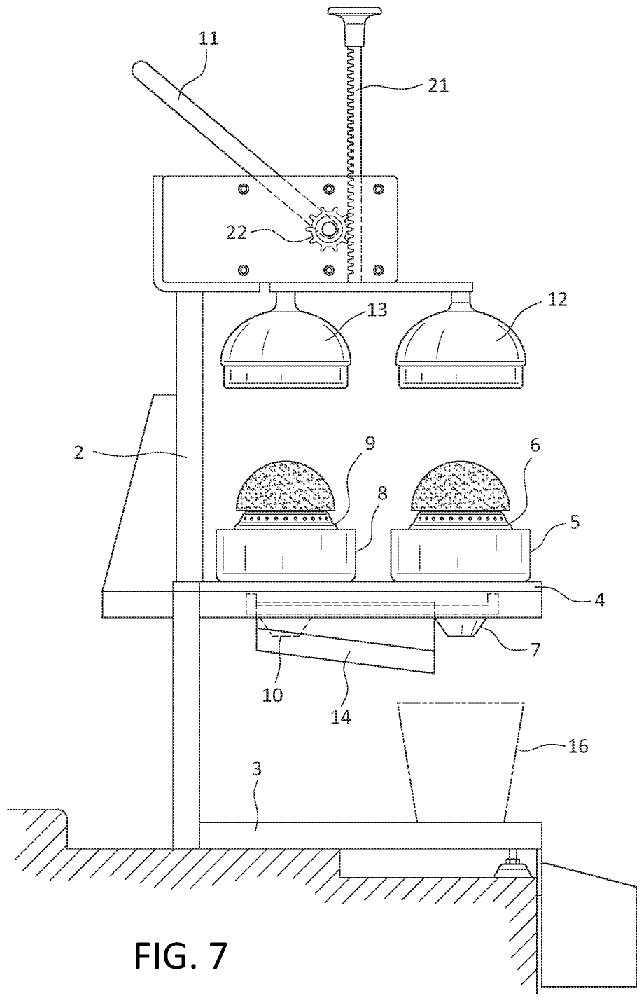

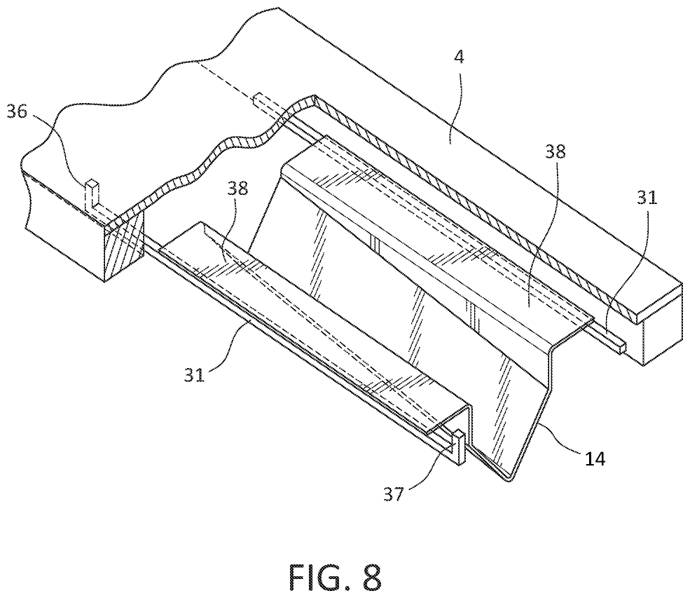

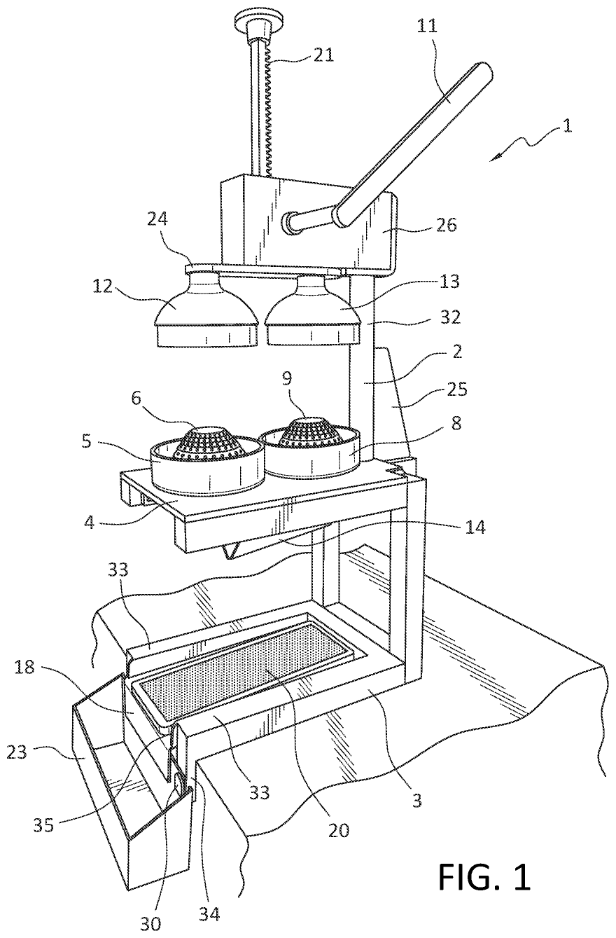

FIG. 1 shows an embodiment of a juicer 1 according to the disclosure. The juicer 1 includes a frame 2 which has a base 3. The frame 2 includes a shelf 4. The shelf 4 accommodate a first drip cup 5 and a second drip cup 8. A first strainer 6 is arranged in the first drip cup 5 and a second strainer 9 is arranged in the second drip cup 8. The first and second strainers 6, 9 can be removably held in the corresponding drip cups 5, 8. Fruit or other material placed on the strainers 6, 9 can be squeezed via at least one pressure element 12. In the embodiment shown in FIG. 1, the juicer 1 includes two pressure elements 12, 13. The first pressure element 12 is configured to press fruit disposed on the first strainer 6 and the second pressure element 13 is configured to press fruit disposed on the second strainer 9. The two pressure elements 12, 13 can also be integrally formed.

A handle 11 is configured to be actuated by a user. The handle 11 can be a one-piece component. When actuated, the handle 11 causes the pressure elements 12, 13 to move downward and engage fruit placed on the strainers 6, 9. In particular, the first pressure element 12 squeezes juice out of fruit deposited on the first strainer 6 and the second pressure element 13 squeezes juice out of the fruit placed on the second strainer 9. The handle 11 causes the first and second pressure elements 12, 13 to apply pressure to the fruit, for example, by moving a vertical member 21 of the rack and pinion assembly 21, 22 holding the pressure elements 12, 13. In an alternative configuration, a single pressure element presses fruit on both strainers 6, 9.

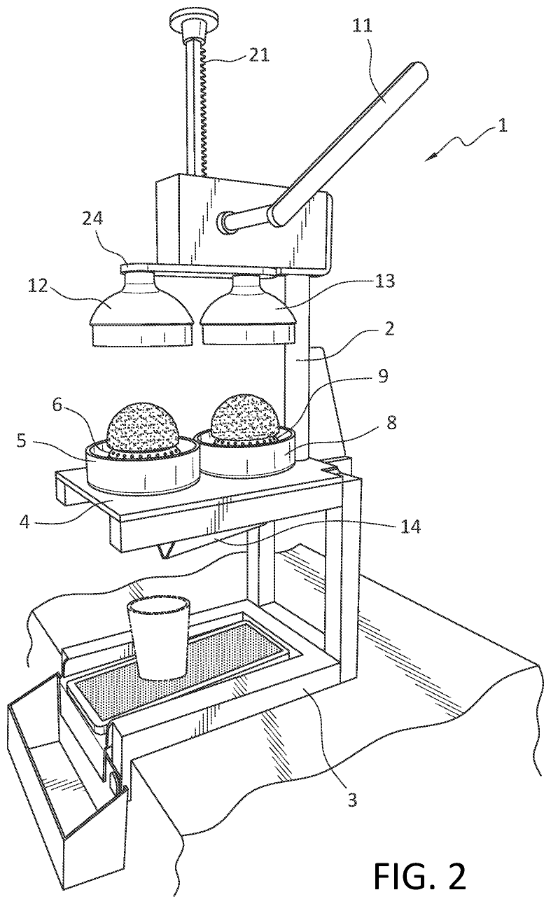

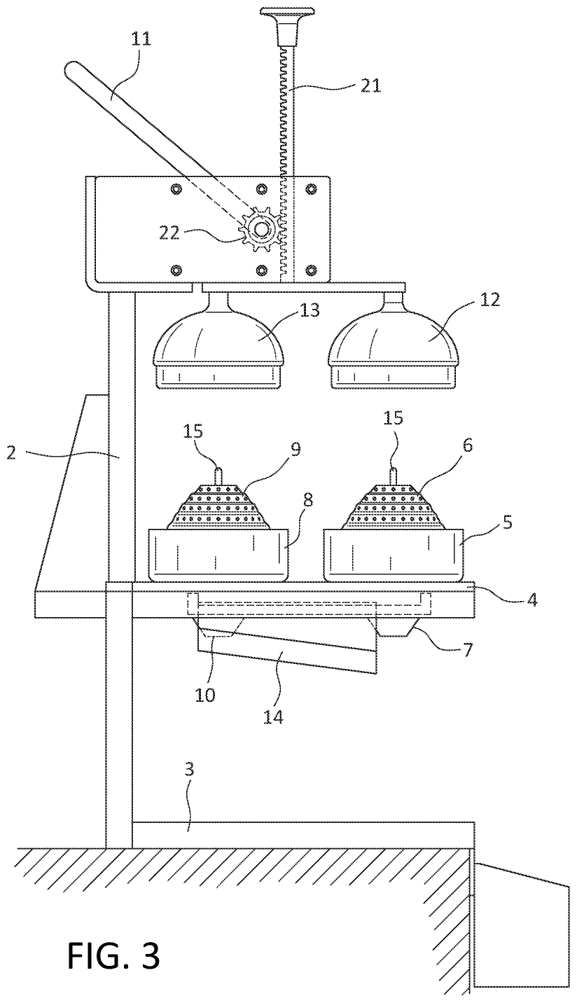

In the embodiment shown in FIG. 1, a rack and pinion gear assembly 21, 22 is used to move the pressure elements 12, 13 down to engage fruit deposited on the strainers 6, 9. The pressure elements 12, 13 can be held via a pressure element support 24. In the embodiment shown in FIG. 2, the rack and pinion gear assembly 21, 22 is disposed above the shelf 4 and is supported via a vertical support member 27 of the frame 2. The rack and pinion gear assembly 21, 22 can at least partially be arranged in a housing 26. When the handle 11 is actuated by a user, the movement of the handle causes the pinion 22 to rotate which, in turn, causes the rack 21 to move up or down in dependence on the direction of the actuation of the handle 11. The rack 21 includes teeth which engage the teeth of the pinion 22. In the embodiment shown in FIG. 3, the rack 21 is positioned centrally with respect to the pressure element support 24 so that pressure is applied equally via both the first pressure element 12 and the second pressure element 13. The handle 11 and the rack and pinion gear assembly 21, 22 can be solidly attached to the frame for additional stability.

The first strainer 6 strains juice pressed from fruit deposited thereon and the juice is directed to a first outlet 7 of the first drip cup 5. The second strainer 9 strains juice pressed from fruit deposited thereon and the juice is directed to a second outlet 10. A first vessel 16 arranged below the first outlet 7 can receive the juice flowing therefrom while a second vessel 17 arranged below the second outlet 10 can receive juice flowing therefrom.

The juicer 1 further has a base 3. The base 3 can be weighted to provide additional stability for the juicer 1. In the embodiment of FIG. 1, the base 3 has two side walls 33 which define a filling area 35 for a vessel 16. The filling area 35 can accommodate two vessels 16, 17. The filling area 35 can define a base surface inclined toward the front of the juicer 1 so as to cause liquid contacting the base surface to flow toward the front of the juicer 1. In FIG. 1, a retaining mat 20 is shown arranged on the base surface and serves to prevent the vessel 16 from sliding on the inclined and possibly moist or wet base surface. The mat 20 can further cause the vessel 16 to be elevated from the base surface and thus avoid being made wet by juice on the base surface. A trough 23 can be arranged at the front of the juicer 1 in order to catch runoff from the base surface. The trough 23 can be removable for emptying and cleaning

The juicer 1 can further have a retaining lip 18 configured to engage the edge of a surface, for example of a table or bar. The retaining lip 18 can inhibit the juicer 1 from sliding on the surface. In the embodiment of FIG. 1, the base surface projects downwardly at the front of the juicer 1 in order to form a retaining lip 18. The side walls 33 can additionally have extensions 34 that project downward at the front of the juicer 1 to prevent the juicer from sliding backwards on the surface. The side wall extensions 34 of FIG. 1 further include attachment arrangements for removably attaching the trough 23 to the front of the juicer 1. The attachment arrangements 30 can be hooks or retaining tables which engages openings in the trough 23 or vice versa. The attachment arrangements 30 can be realized by any other suitable removable attachment method.

In FIG. 2, the juicer 1 of FIG. 1 is shown with fruit placed on each of the first strainer and the second strainer. The juicer 1 has a diverter 14. The diverter 14 in the embodiment shown in FIG. 2 is in a first position. In this first position, juice discharged from the first outlet 7 flows into a vessel 16 disposed under the first outlet 7 and juice discharged from the second outlet 10 is guided to the vessel 16 by the diverter 14.

FIG. 3 shows an embodiment wherein the strainers include a retaining pin 15. The retaining pin 15 holds fruit deposited thereon and prevents the same from becoming dislodged prior to and during the pressing process when the handle 11 is actuated. The retaining pin 15 can pierce the flesh of the fruit to hold the same in place. The retaining pin 15 can, for example, be approximately a quarter inch in length and can have a pointed tip.

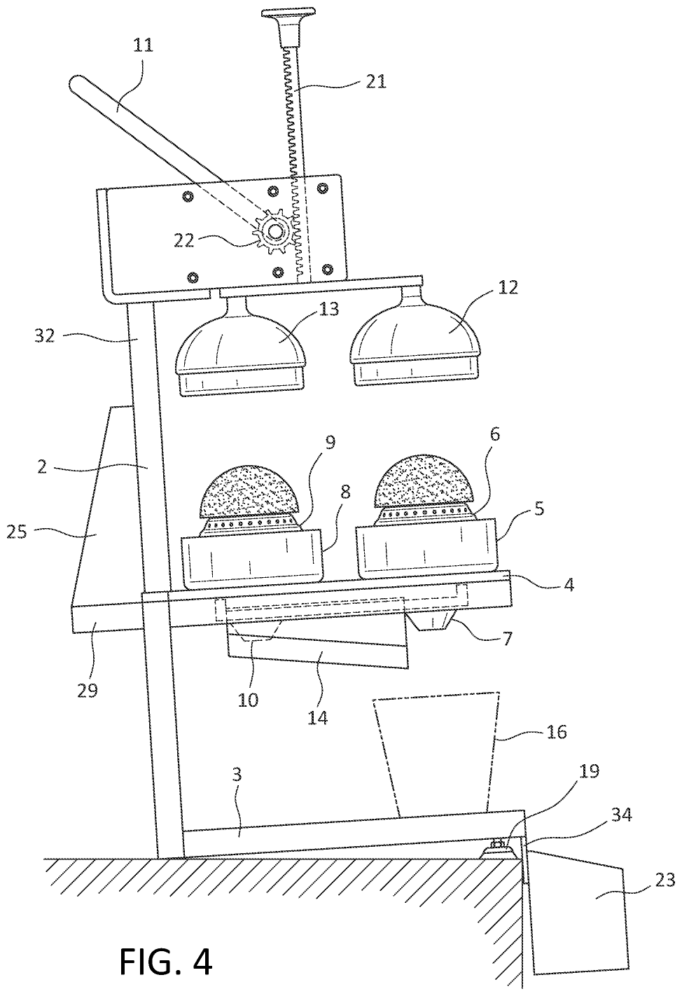

In the embodiment of FIG. 4, the juicer 1 includes feet 19. The feet 19 can be adjustable in height. As shown in FIG. 4, the adjustable feet 19 can be used to alter the pitch of the juicer 1 and to counter forces pushing/pulling the juicer 1 forward when the handle 11 is actuated. In particular, the feet 19 can counter a pivot force introduced when the handle 11 is actuated. The handle 11 is in a non-actuated position in FIG. 4 so that the pressure elements 12, 13 are in a raised position and not engaging the fruit to press juice therefrom.

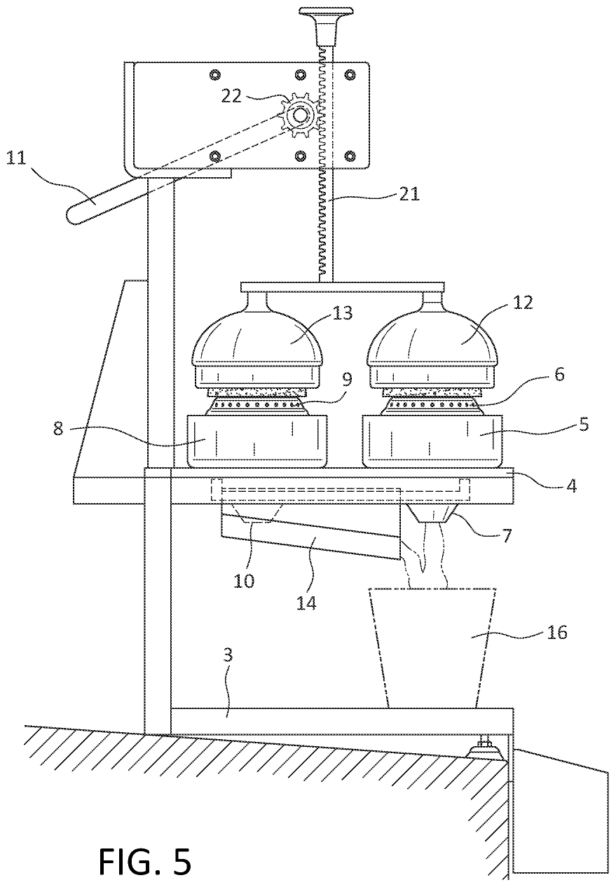

FIG. 5 shows the juicer of FIG. 1 with the diverter 14 in the first position and the handle 11 fully actuated so that the pressure elements 12, 13 are in a lowered position whereat they press juice from the fruit deposited on the strainers 6, 9. In the first position of the diverter 14, the diverter 14 allows juice to flow from the outlet 7 into the vessel 16 arranged below the outlet 7. Further, the diverter 14 guides juice or other liquid discharged from the outlet 10 to the same vessel 16. As a result, the juice squeezed from the fruit disposed on each of the strainers 6, 9 is directed into a single cup. This enables a user to double the rate at which the vessel 16 is filled with juice compared to a conventional juicer.

The juicer 1 shown in FIG. 5 is disposed on a slanted surface and the adjustable feet 19 are used to compensate for the slant in the surface. That is, the adjustable feet 19 can be used to level the juicer 1 on an uneven surface or the adjustable feet can be further extended to further increase the pitch of the juicer 1 so as to counter forces generated when the handle 11 is actuated.

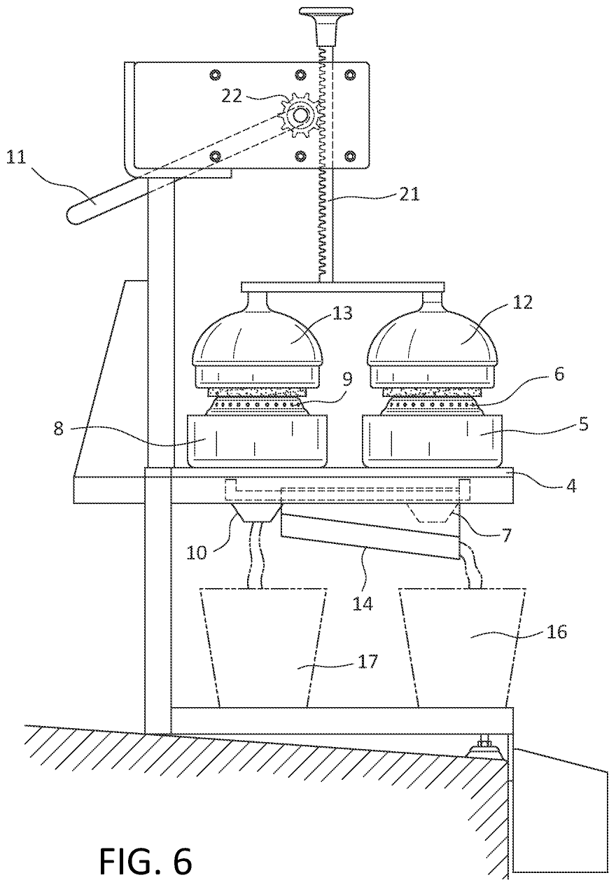

In FIG. 6, the juicer 1 is shown with the diverter 14 in the second position and the handle 11 actuated so that the pressure elements 12, 13 are in the lowered position whereat they each press fruit deposited on respective ones of the strainers 6, 9. In FIG. 6, two vessels 16, 17 are disposed in the filling area 35. The second vessel 17 receives juice discharged from the second outlet 10 of the second drip cup 8 while the first vessel 16 receives juice from the first outlet 7 of the first drip cup 5. In the embodiment shown in FIG. 6, the juice discharged from the first outlet 7 is directed to the first vessel 16 by the diverter 14, which is in the second position.

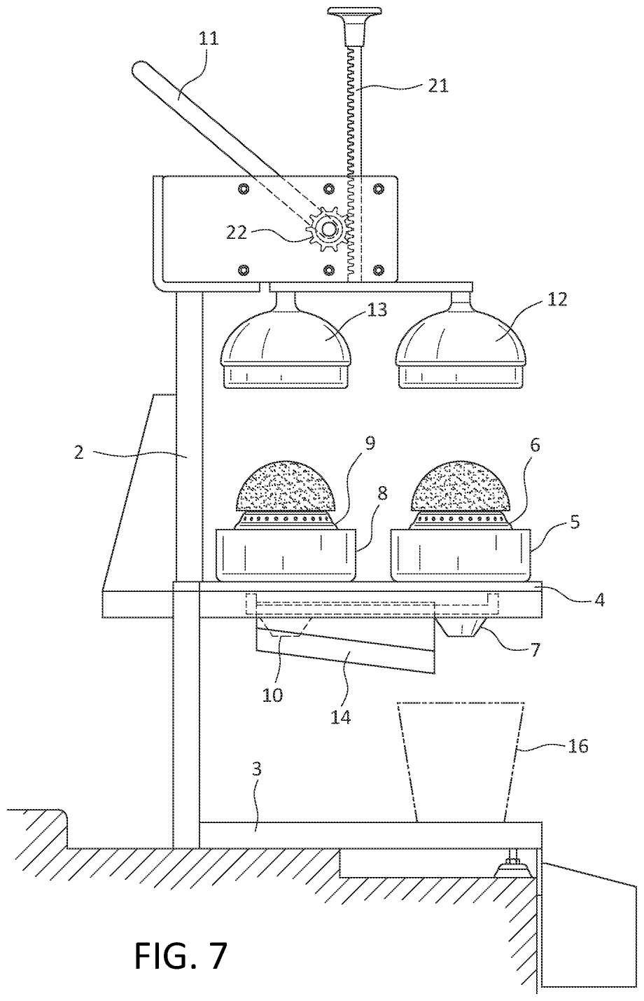

FIG. 7 shows the juicer 1 with the diverter 14 in the first position. A single vessel 16 is disposed below the first outlet 7. The handle 11 is in a non-actuated position so that the pressure elements 12, 13 are in a raised position where they do not engage the fruit deposited on the strainers. In this position, the fruit can be removed and fresh fruit can be placed on the strainers. The adjustable feet 19 compensate for a stepped bar or surface in FIG. 7. The front portion of the surface is at a lower elevation than the rear portion of the surface and the adjustable feet 19 elevate the front portion of the juicer 1 so as to level the juicer 1 or the adjustable feet 19 can be further extended so that the juicer 1 leans rearward.

In some embodiments, the juicer 1 has a reinforcement member 28 to reinforce the frame 2. In the embodiment shown in FIG. 6, the shelf 4 has a shelf extension 29. The reinforcement member 28 has a lower portion arranged on the shelf extension 29 and connects to the vertical support member 32 in order to reinforce the juicer 1, in particular, the vertical support member 32 and the connection between the shelf 4 and the vertical support member 32. The reinforcement member 28 can taper in the vertical direction.

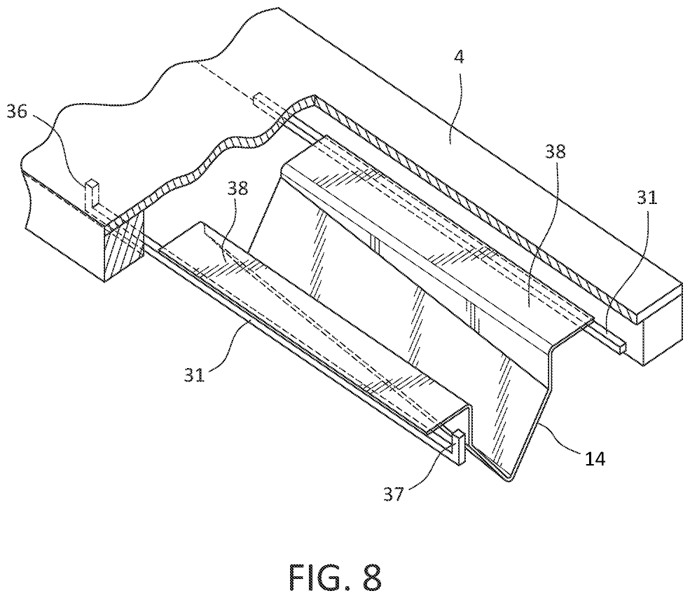

FIG. 8 shows an embodiment of the diverter 14 in more detail. The shelf 4 includes a guide rail 31 on either side of the shelf 4. The diverter 14 has guide portion 38 configured to engage the rail. The diverter 14 can be moved along the rail at least between the first position of the diverter 14 and the second position of the diverter 14. The guide rail 31 can have a first stop 36 defining the first position of the diverter 14. The first stop 36 can further delimit the movement of the diverter 14 in the rearward direction. The guide rail 31 can further have a second stop 37 defining the second position of the diverter 14. The second stop 37 can further prevent the diverter 14 from sliding off the rails in the forward direction. In the first position of the diverter 14, juice discharged from both the first outlet 7 and the second outlet 10 flow into a first vessel 16. The diverter 14 guides juice discharged from the second outlet 10 into the first vessel 16 while the juice discharged from the first outlet 7 flows directly into the vessel 16.

According to an embodiment, the diverter 14 in FIG. 8 has a V-shape creating a channel for the juice to flow. The channel defined by the diverter 14 extends forward with a downward slope so as to cause juice to flow from the back of the diverter 14 toward the front thereof. In particular the diverter 14 can extend further downward from the shelf 4 in the front portion of the diverter 14 than in the rear thereof. However, the configuration of the diverter 14 could be mirrored so that the juicer 1 fills the rear vessel 17 when the diverter 14 is in the first position.

According to an embodiment, the diverter 14 can be removed from the rails 31 for cleaning, for example by lifting guide portions 38 over the second stop 37.

It is understood that the foregoing description is that of the preferred embodiments of the invention and that various changes and modifications may be made thereto without departing from the spirit and scope of the invention as defined in the appended claims.

### REFERENCE NUMERALS

1. Juicer/Juicing device
2. Frame
3. Base
4. Shelf
5. First drip cup
6. First strainer
7. First outlet
8. Second drip cup
9. Second strainer
10. Second outlet
11. Handle
12. First pressure element
13. Second pressure element
14. Diverter
15. Retaining pin
16. First vessel
17. Second vessel
18. Retaining lip
19. Adjustable feet
20. Mat
21. Rack member
22. Pinion
23. Trough
24. Pressure element support
25. Reinforcement member
26. Housing
27. Vertical support member
29. Shelf extension
30. Attachment arrangements
31. Guide rail
32. Vertical support member
33. Side walls
34. Extensions
35. Filling area
36. First stop
37. Second stop
38. Guide portion of the diverter

What is claimed is:

1. A juicing device comprising:
a frame having a base;
a first drip cup mounted on said frame and having a first outlet;
a second drip cup mounted on said frame and having a second outlet;
a first strainer configured to have fruit to be juiced placed thereon;
a second strainer configured to have fruit to be juiced placed thereon;
said first drip cup being configured to accommodate said first strainer;
said second drip cup being configured to accommodate said second strainer;
an actuator configured to be actuated by a user;
a first pressure element operatively connected to said actuator and being configured, when said actuator is actuated, to press fruit deposited on said first strainer;
a second pressure element operatively connected to said actuator and being configured, when said actuator is actuated, to press fruit deposited on said second strainer; and,
said first outlet and said second outlet being configured to guide juice from corresponding ones of said first drip cup and said second drip cup to at least one vessel filling area below said first drip cup and said second drip cup.

2. The juicing device of claim 1 further comprising:
a diverter configured to receive juice from at least one of said first outlet of said first drip cup and said second outlet of said second drip cup;
said diverter being displaceable to a first position and a second position; and,
said diverter being configured to direct juice from said first outlet and said second outlet to a single vessel when said diverter is in said first position.

3. The juicing device of claim 2, wherein, when said diverter is in said second position, said outlet of said first drip cup is configured to supply juice to a first vessel and said outlet of said second drip cup is configured to supply juice to a second vessel.

4. The juicing device of claim 1, wherein said first strainer includes a retaining pin configured to hold fruit on said first strainer.

5. The juicing device of claim 1, wherein the juicing device is mountable on a support surface defining an edge; and, said base includes a front end having a retaining lip configured to engage the edge of the support surface so as to prevent the juicing device from moving in a direction away from the edge of the support surface.

6. The juicing device of claim 1, wherein said base includes at least two adjustable feet.

7. The juicing device of claim 6, wherein said base defines a front end and a bottom; and, said at least two adjustable feet are arranged on said bottom at said front end and are configured to tilt said frame away from said front end when said feet are extended.

8. The juicing device of claim 6, wherein said at least two adjustable feet are configured to adapt to a bar having a stepped and/or slanted surface.

9. The juicing device of claim 1, wherein said actuator is a handle.

10. The juicing device of claim 9 further comprising:
a rack and pinion gear assembly; and,
said handle being connected to said first pressure element and said second pressure element via said rack and pinion gear assembly and to move said first pressure element and said second pressure element via said rack and pinion gear assembly.

11. The juicing device of claim 10, wherein said rack and pinion gear assembly includes a linear rack and a circular gear; said handle is configured to rotate said circular gear when actuated; and, said linear gear is configured to act on said first pressure element and said second pressure element with equal force.

12. The juicing device of claim 1 further comprising:
a trough;
the juicing device having a front end and a back end;
said frame defining a vessel deposition surface;
said vessel deposition surface defining an incline from said front end of the juicing device toward said back end of the juicing device;
said trough being removably arranged at said front end and configured to receive liquid flowing down said incline.

13. The juicing device of claim 12, wherein said frame includes two lower side walls defining said vessel deposition surface therebetween so as to define a channel leading to said trough.

14. The juicing device of claim 1, wherein said first outlet guides juice to a filling area for a first vessel and said second outlet guides juice to a filling area for a second vessel.
